(19) United States
(12) Patent Application Publication
(10) Pub. No.: US 2025/0184776 A1
(43) Pub. Date: Jun. 5, 2025

(54) METHODS AND SYSTEMS FOR ASSESSING WIRELESS LINK QUALITY

(71) Applicant: Nile Global, Inc., San Jose, CA (US)

(72) Inventor: Guru Prasanna Gopalakrishnan, San Jose, CA (US)

(21) Appl. No.: 18/527,821

(22) Filed: Dec. 4, 2023

(51) Int. Cl. H04W 24/08

(52) U.S. Cl. CPC H04W 24/08

(57) ABSTRACT

Embodiments of a wireless device and method are disclosed. In an embodiment, a method for assessing wireless link quality involves at a wireless device, monitoring at least one of user traffic and a wireless channel characteristic to generate wireless link quality factors, where each of the wireless link quality factors has a fixed number of possible outcomes, and at the wireless device, determining an overall wireless link quality assessment based on the wireless link quality factors using a truth table.

### BACKGROUND

Growing adoption of networks, such as, enterprise campus networks allows enterprises to increase network coverage and functionality. For example, due to the dynamic nature of the business and campuses, switches, gateways, wireless access points (APs), and/or client devices, such as, laptops, printers, servers, security cameras, and/or other connected Internet of things (IoT) devices are typically interconnected in a network. Wireless network management, for example, wireless link quality assessment, plays an important role in ensuring that network design, deployments and/or operations meet agreed upon commitments. However, wireless link quality assessment can be difficult to implement due to varying wireless channel conditions and/or interference. Therefore, there is a need for network technology that can provide wireless link quality assessment for a network with wireless capabilities.

### SUMMARY

Embodiments of a wireless device and method are disclosed. In an embodiment, a method for assessing wireless link quality involves at a wireless device, monitoring at least one of user traffic and a wireless channel characteristic to generate wireless link quality factors, where each of the wireless link quality factors has a fixed number of possible outcomes, and at the wireless device, determining an overall wireless link quality assessment based on the wireless link quality factors using a truth table. Other embodiments are also described.

In an embodiment, a network management action is triggered based on the overall wireless link quality assessment.

In an embodiment, the method further includes triggering a network management action based on the overall wireless link quality assessment.

In an embodiment, the overall wireless link quality assessment is good, average, or bad.

In an embodiment, each of the wireless link quality factors is good, average, or bad.

In an embodiment, at the wireless device, determining the overall wireless link quality assessment based on the wireless link quality factors using the truth table includes at the wireless device, determining the overall wireless link quality assessment as being good when each of the wireless link quality factors is good.

In an embodiment, at the wireless device, determining the overall wireless link quality assessment based on the wireless link quality factors using the truth table includes at the wireless device, determining the overall wireless link quality assessment as being bad when one of the wireless link quality factors is bad.

In an embodiment, the wireless link quality factors include a transmit/receive (Tx/Rx) rate combination optimality factor, a per packet downlink latency factor, and a miscellaneous wireless link quality factor.

In an embodiment, at the wireless device, monitoring at least one of the user traffic and the wireless channel characteristic to generate the wireless link quality factors includes determining the Tx/Rx rate combination optimality factor based on a rate optimality function.

In an embodiment, at the wireless device, monitoring at least one of the user traffic and the wireless channel characteristic to generate the wireless link quality factors includes generating a downlink rate optimality score based on a rate optimality function or generating an uplink rate optimality score based on the rate optimality function.

In an embodiment, the wireless link quality factors include uplink wireless link quality factors, and the overall wireless link quality assessment includes an overall uplink wireless link quality assessment.

In an embodiment, the wireless link quality factors include downlink wireless link quality factors, and the overall wireless link quality assessment include an overall downlink wireless link quality assessment.

In an embodiment, the wireless device includes a wireless access point (AP).

In an embodiment, the wireless device includes a wireless station (STA).

In an embodiment, a wireless device includes a wireless transceiver; and a controller connected to the wireless transceiver and configured to using the wireless transceiver, monitor at least one of user traffic and a wireless channel characteristic to generate wireless link quality factors, where each of the wireless link quality factors has a fixed number of possible outcomes and determine an overall wireless link quality assessment based on the wireless link quality factors using a truth table.

In an embodiment, a network management action is triggered based on the overall wireless link quality assessment.

In an embodiment, the controller is further configured to trigger a network management action based on the overall wireless link quality assessment.

In an embodiment, the overall wireless link quality assessment is good, average, or bad.

In an embodiment, each of the wireless link quality factors is good, average, or bad.

In an embodiment, a method for assessing wireless link quality involves at a wireless access point (AP), monitoring at least one of user traffic and a wireless channel characteristic to generate wireless link quality factors, where each of the wireless link quality factors has a fixed number of possible outcomes, and where the wireless link quality factors comprise a transmit/receive (Tx/Rx) rate combination optimality factor, a per packet downlink latency factor, and a miscellaneous wireless link quality factor, at the wireless AP, determining an overall wireless link quality assessment based on the wireless link quality factors using a truth table, where the overall wireless link quality assessment is good, average, or bad, and triggering a network management action based on the overall wireless link quality assessment.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a communications system in accordance to an embodiment of the invention.

FIG. 2 depicts an embodiment of a network device of the communications system depicted in FIG. 1.

FIG. 3 depicts a network that can be included in the communications system depicted in FIG. 1.

FIG. 4 depicts a network that includes multiple wireless devices that are implemented as wireless APs.

FIG. 5 is a process flow diagram of a method for assessing wireless link quality in accordance to an embodiment of the invention.

FIG. 6 is a process flow diagram of a method for assessing wireless link quality in accordance to an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

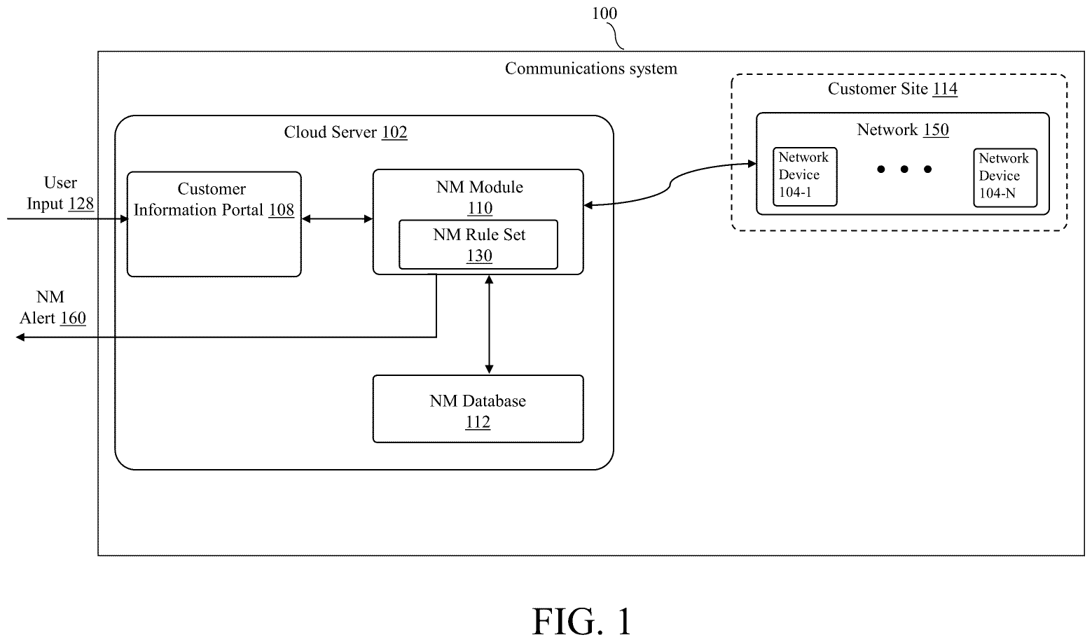

FIG. 1 depicts a communications system 100 in accordance to an embodiment of the invention. In the embodiment depicted in FIG. 1, the communications system includes a cloud server 102 and at least one deployed network 150 within a customer site 114. The cloud server and/or the deployed network may be implemented in hardware (e.g., circuits), software, firmware, or a combination thereof. Although the illustrated communications system 100 is shown with certain components and described with certain functionality herein, other embodiments of the communications system may include fewer or more components to implement the same, less, or more functionality. For example, in some embodiments, the communications system includes more than one cloud server, more than one deployed network, and/or more than one customer site. In another example, although the cloud server and the deployed network are shown in FIG. 1 as being connected in certain topology, the network topology of the communications system 100 is not limited to the topology shown in FIG. 1.

The cloud server 102 can be used to provide at least one service to a customer site (e.g., to the deployed network 150 located at the customer site 114). The cloud server may be configured to facilitate or perform a wireless link quality assessment service to network devices (e.g., the deployed network 150) at the customer site. Because the cloud server can facilitate or perform a wireless link quality assessment service to network devices at the customer site, network management efficiency can be improved. In addition, because the cloud server can facilitate or perform a wireless link quality assessment service to network devices at the customer site, a user or customer of the customer site can be notified of network outage. Consequently, network outage time can be reduced. In some embodiments, the cloud server is configured to generate a user interface to obtain input information, for example, a floor plan of a customer site. In some embodiments, the user interface includes a graphical user interface. The cloud server may be implemented in hardware (e.g., circuits), software, firmware, or a combination thereof. In some embodiments, the cloud server is hosted or executed in a public cloud computing environment such as Amazon Web Services (AWS), and/or a private cloud computing environment such as an enterprise cloud server. In some embodiments, the cloud server is implemented on a server grade hardware platform, such as an x86 architecture platform. For example, the hardware platform of the cloud server may include conventional components of a computing device, such as one or more processors (e.g., central processing units (CPUs)), system memory, a network interface, storage system, and other Input/Output (I/O) devices such as, for example, a mouse and a keyboard (not shown). In some embodiments, the processor is configured to execute instructions, for example, executable instructions that may be used to perform one or more operations described herein and may be stored in the memory and the storage system. In some embodiments, the memory is volatile memory used for retrieving programs and processing data. The memory may include, for example, one or more random access memory (RAM) modules. In some embodiments, the network interface is configured to enable the cloud server to communicate with another device via a communication medium. The network interface may be one or more network adapters, also referred to as a Network Interface Card (NIC). In some embodiments, the cloud server includes local storage devices (e.g., one or more hard disks, flash memory modules, solid state disks and optical disks) and/or a storage interface that enables the host to communicate with one or more network data storage systems, which are used to store information, such as executable instructions, cryptographic keys, virtual disks, configurations, and other data.

In the embodiment depicted in FIG. 1, the cloud server 102 includes a network management (NM) module 110, a customer information portal 108 connected to the NM module 110, and an NM database 112 configured to store NM data. The NM module, the customer information portal, and/or the NM database may be implemented in hardware (e.g., circuits), software, firmware, or a combination thereof. Although the illustrated cloud server is shown with certain components and described with certain functionality herein, other embodiments of the cloud server may include fewer or more components to implement the same, less, or more functionality. For example, in some embodiments, the cloud server includes more than one NM module, more than one customer information portal, and/or more than one NM database. In another example, although the NM module, the customer information portal, and the NM database are shown in FIG. 1 as being connected in certain topology, the network topology of the cloud server is not limited to the topology shown in FIG. 1. In addition, although the customer information portal 108 is shown in FIG. 1 as being a component of the cloud server 102, in other embodiments, the customer information portal may be implemented outside of the cloud server. In some embodiments, the NM module 110 is configured to facilitate or perform a wireless link quality assessment service to network devices (e.g., the deployed network 150) at the customer site 114, for example, using a network management (NM) rule set 130. The NM rule set 130 may include one or more NM rules for network devices at the customer site 114, for example, for performing an NM service to network devices at the customer site 114. In some embodiments, the NM module 110 is configured to generate and/or transmit at least one NM alert 160 regarding a network deployed and/or to be deployed at the customer site, for example, to an administrator or a user or customer (e.g., a layperson such as a worker on-site or an end-user such as an employee) at the customer site 114. In some embodiments, the NM database 112 is configured to store NM data for a network deployed and/or to be deployed at the customer site (e.g., a list of network devices deployed or to be deployed at the customer site). For example, the NM database 112 is configured to store NM measurement data and/or a list of specific levels of network availability, coverage and/or capacity for network devices deployed at the customer site 114. In some embodiments, the NM database 112 is configured to store the at least one NM alert 160. Because the NM module can facilitate or perform an NM service (e.g., a wireless link quality assessment service) to network devices at the customer site, network management efficiency can be improved. In addition, because the NM module can facilitate or perform an NM service to network devices at the customer site, a user or customer (e.g., a layperson such as a worker on-site or an end-user such as an employee) at the customer site can be notified of network conditions or outrages. Consequently, network outage time can be shortened. The customer information portal 108 is configured to receive customer input 128. In some embodiments, the customer information portal is configured to include or generate a user interface that allows a customer to input information related to the customer site 114 (e.g., the floor plan of the customer site 114) and/or information associated with an NM service (e.g., a wireless link quality assessment service) for the customer site 114, such as one or more specific requirements or restrictions.

In the communications system 100 depicted in FIG. 1, the customer site 114 may include one or more buildings, and each building may include one or more floors. Network devices that can be deployed at the customer site may include any type of suitable network devices. For example, network devices may be designated to be deployed to a specific building, a specific floor within a building, and/or a specific location on a floor of a building. A network device that can be deployed at the customer site may be fully or partially implemented as an Integrated Circuit (IC) device. In the embodiment depicted in FIG. 1, the network 150 includes one or more network devices 104-1, . . . , 104-N, where Nis a positive integer. In some embodiments, at least one of the one or more network devices 104-1, . . . , 104-N is a wired and/or wireless communications device that includes at least one processor (e.g., a microcontroller, a digital signal processor (DSP), and/or a CPU), at least one wired or wireless communications transceiver implemented in one or more logical circuits and/or one or more analog circuits, at least one wired or wireless communications interface and that supports at least one wired or wireless communications protocol, and/or at least one antenna. For example, at least one of the network devices 104-1, . . . , 104-N is compatible with Institute of Electrical and Electronics Engineers (IEEE) 802.3 protocol and/or one or more wireless local area network (WLAN) communications protocols, such as an IEEE 802.11 protocol, and/or a short-range communications protocol, such as Bluetooth. In some embodiments, at least one of the network devices 104-1, . . . , 104-N is a wired communications device that is compatible with at least one wired local area network (LAN) communications protocol, such as a wired router (e.g., an Ethernet router), a wired switch, a wired hub, or a wired bridge device (e.g., an Ethernet bridge). In some embodiments, at least one of the network devices 104-1, . . . , 104-N is a wireless access point (AP) that connects to a local area network (e.g., a LAN) and/or to a backbone network (e.g., the Internet) through a wired connection and that wirelessly connects to wireless stations (STAs), for example, through one or more WLAN communications protocols, such as an IEEE 802.11 protocol. In some embodiments, the network 150 includes at least one distribution switch (DS) or distribution layer switch that functions as a bridge between a core layer switch and an access layer switch, at least one head end (HE) or gateway, at least one access switch (AS) that can directly interact with a lower-level device (e.g., a wireless AP), at least one wireless AP, and/or at least one wireless sensor that wirelessly connects to a wireless AP. In some embodiments, at least one of the network devices 104-1, . . . , 104-N is a wireless station (STA) that wirelessly connects to a wireless AP. For example, at least one of the network devices 104-1, . . . , 104-N may be a laptop, a desktop personal computer (PC), a mobile phone, or other wireless device that supports at least one WLAN communications protocol (e.g., an IEEE 802.11 protocol).

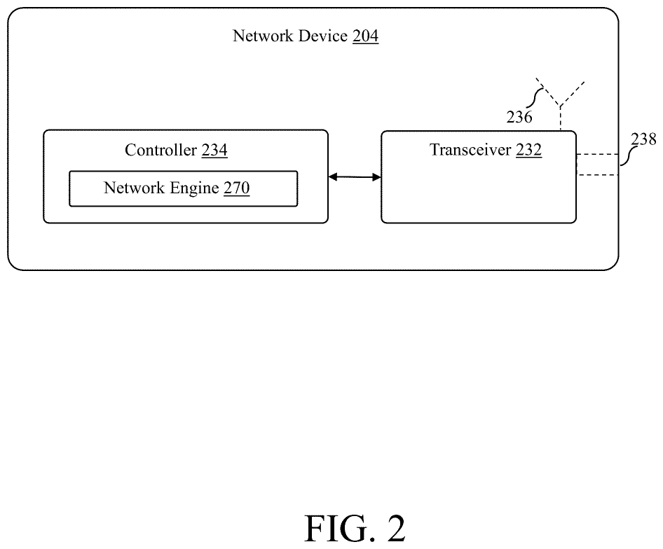

FIG. 2 depicts an embodiment of a network device 204 of the communications system 100 depicted in FIG. 1. The network device 204 may be an embodiment of a network device 104-1, . . . , or 104-N that is included in the deployed network 150 in FIG. 1. However, network devices that can be included in the deployed network 150 depicted in FIG. 1 are not limited to the embodiment depicted in FIG. 2. The network device 204 may be any suitable type of network device. For example, the network device 204 may be a distribution switch (DS), a gateway or headend (HE), an access switch (AS), a wireless access point (AP), a sensor, a laptop, a desktop personal computer (PC), or a mobile phone.

In the embodiment depicted in FIG. 2, the network device 204 includes at least one wireless and/or wired transceiver 232, at least one optional antenna 236 operably connected to the transceiver 232, at least one optional network port 238 operably connected to the transceiver 232, and a controller 234 operably connected to the transceiver 232. In some embodiments, the transceiver 232 includes a physical layer (PHY) device. The transceiver 232 may be any suitable type of transceiver. For example, the transceiver 232 may be an LAN transceiver (e.g., an Ethernet transceiver), a short-range communications transceiver (e.g., a Bluetooth or Bluetooth Low Energy (BLE) transceiver), or a WLAN transceiver (e.g., a transceiver compatible with an IEEE 802.11 protocol). In some embodiments, the network device 204 includes multiple transceivers, for example, an LAN transceiver (e.g., an Ethernet transceiver), a short-range communications transceiver (e.g., a Bluetooth or BLE transceiver), and/or a WLAN transceiver (e.g., a transceiver compatible with an IEEE 802.11 protocol). For example, the network device 204 includes a WLAN transceiver (e.g., a transceiver compatible with an IEEE 802.11 protocol) and a short-range communications transceiver (e.g., a Bluetooth or BLE transceiver). In some embodiments, the network device (e.g., a wireless AP) includes multiple antennas and multiple wireless transceivers that share the antennas. In some embodiments, the controller 234 is configured to control the transceiver 232 to process packets received through the antenna 236 and/or the network port 238 and/or to generate outgoing packets to be transmitted through the antenna 236 and/or the network port 238. In some embodiments, the controller 234 is configured to obtain and/or store information relevant to the network device 204 (e.g., security information relevant to the network device 204, such as, security certificate information). For example, the controller 234 may be configured to obtain and/or store security information relevant to the network device 204 such as security certificate information. In some embodiments, the controller 234 includes a storage device (e.g., one or more hard disks, flash memory modules, solid state disks, and/or optical disks) that contains or stores predefined information (e.g., a predefined security certificate), which may be placed or embedded into the network device during a manufacturing process. In some embodiments, the controller 234 is implemented using at least one processor (e.g., a microcontroller, a DSP, and/or a CPU). In some embodiments, the controller 234 executes one or more Layer 3 or L3 (i.e., the network layer, which is the third level (Layer 3) of the Open Systems Interconnection Model (OSI Model)) protocols, for example, an Internal Gateway Protocol (IGP) (e.g., an Open Shortest Path First (OSPF) protocol), a Border Gateway Protocol (BGP), or an Intermediate System to Intermediate System (IS-IS) protocol. The controller 234 may include a processor (e.g., a microcontroller, a DSP, and/or a CPU) configured to execute one or more Layer 3 (L3) protocols, and memory that may store information (e.g., an operation system (OS)) for the processor. The antenna 236 may be any suitable type of antenna. For example, the antenna 236 may be an induction type antenna such as a loop antenna or any other suitable type of induction type antenna. However, the antenna 236 is not limited to an induction type antenna. The network port 238 may be any suitable type of port. For example, the network port 238 may be a local area network (LAN) network port such as an Ethernet port. However, the network port 238 is not limited to LAN network ports. In some embodiments, the network device 204 is a wireless communications device that includes at least one wireless transceiver (e.g., the transceiver 232) and at least one antenna (e.g., the antenna 236). In some embodiments, as a wireless device, the network device 204 includes at least one network port (e.g., the network port 238) that is used to connect to another communication device through at least one cable or wire, for example, at least one Ethernet cable. In some embodiments, the network device 204 is a wired communications device that includes at least one wired transceiver (e.g., the transceiver 232) and at least one network port (e.g., the network port 238) that is used to connect to another communication device through at least one cable or wire, for example, at least one Ethernet cable. In some embodiments, as a wired device, the network device 204 includes a wireless transceiver and at least one antenna (e.g., the antenna 236).

In the embodiment depicted in FIG. 2, the network device 204 (e.g., the controller 234) includes a network engine 270 configured to execute one or more communications protocols. In some embodiments, the network engine 270 is configured to execute Layer 3 (L3) protocols, for example, an Internal Gateway Protocol (IGP) (e.g., an Open Shortest Path First (OSPF) protocol), a Border Gateway Protocol (BGP), or an Intermediate System to Intermediate System (IS-IS) protocol. In some embodiments, the network engine 270 includes or is implemented using a processor (e.g., a microcontroller, a DSP, and/or a CPU) configured to execute one or more communications protocols (e.g., Layer 3 (L3) protocols), and memory that may store information (e.g., an OS) for the processor. For example, the controller 234 is implemented using a processor and memory, and the network engine 270 is a software module that executes in the processor. In some embodiments, the controller 234 (e.g., the network engine 270) includes a storage device (e.g., one or more hard disks, flash memory modules, solid state disks, and/or optical disks) that contains or stores predefined information (e.g., a predefined security certificate), which may be placed or embedded into the network device 204 during a manufacturing process.

Owing to the unpredictable nature of wireless channels versus wireline channels, radio frequency (RF) link quality is most often a deciding factor when it comes to the wireless end user experience and hence it becomes crucial to be able to effectively approximate it to diagnose/potentially address any Quality of Experience (QOE) degradation for wireless clients. In some embodiments, the controller 234 is configured to using the transceiver 232, monitor at least one of user traffic and a wireless channel characteristic to generate wireless link quality factors, where each of the wireless link quality factors has a fixed number of possible outcomes and determine an overall wireless link quality assessment based on the wireless link quality factors using a truth table. In some embodiments, the controller 234 uses the transceiver 232 to monitor only user traffic to generate wireless link quality factors. In some embodiments, the controller 234 uses the transceiver 232 to monitor only a wireless channel characteristic to generate wireless link quality factors. In some embodiments, the controller 234 uses the transceiver 232 to monitor multiple wireless channel characteristics to generate wireless link quality factors. In some embodiments, the controller 234 uses the transceiver 232 to monitor user traffic and a wireless channel characteristic to generate wireless link quality factors. In some embodiments, the controller 234 uses the transceiver 232 to monitor user traffic and multiple wireless channel characteristics to generate wireless link quality factors. In some embodiments, user traffic is measured by the amount of data moving across a computer network (e.g., the communications system 100) at any given time. Examples of user traffic include, without being limited to, voice traffic, video traffic, and/or data traffic. In some embodiments, user traffic is wireless user traffic that is communicated wirelessly. Examples of the wireless channel characteristics include, without being limited to, channel load (self and Overlapping Basic Service Set (OBSS) load), noise floor, and/or non-Wi-Fi interference. In some embodiments, a network management action is triggered based on the overall wireless link quality assessment. For example, the controller is configured to trigger a network management action based on the overall wireless link quality assessment. In some embodiments, the overall wireless link quality assessment is good, average, or bad. In some embodiments, each of the wireless link quality factors is good, average, or bad. In some embodiments, the controller is configured to determine the overall wireless link quality assessment as being good when each of the wireless link quality factors is good. In some embodiments, the controller is configured to determine the overall wireless link quality assessment as being bad when one of the wireless link quality factors is bad. In some embodiments, the wireless link quality factors include a transmit/receive (Tx/Rx) rate combination optimality factor, a per packet downlink latency factor, and a miscellaneous wireless link quality factor. In some embodiments, the controller is configured to determine the Tx/Rx rate combination optimality factor based on a rate optimality function. In some embodiments, the controller is configured to generate a downlink rate optimality score based on a rate optimality function or generate an uplink rate optimality score based on the rate optimality function. In some embodiments, the wireless link quality factors include uplink wireless link quality factors, and the overall wireless link quality assessment includes an overall uplink wireless link quality assessment. In some embodiments, the wireless link quality factors include downlink wireless link quality factors, and the overall wireless link quality assessment includes an overall downlink wireless link quality assessment.

The overall wireless link quality assessment (e.g., RF link quality index) not only can come in handy to assist with monitoring/troubleshooting any client specific radio performance degradation problems but also can help derive necessary insights into the overall performance of a wireless network by aggregating RF link quality indices for multiple clients (e.g., AP/floor/building level etc.). Further, the overall wireless link quality assessment (e.g., RF link quality index) can provide a means to quantify the effectiveness of certain features (e.g., channel planning, stick client handling) that has a direct impact on the overall link budget of the wireless clients in a network as detailed below.

In some embodiments, the overall wireless link quality assessment (e.g., RF link quality index) is used for channel planning, for example, to check the optimality of channel parameters allocation (e.g., operating channel, channel bandwidth, transmit power, and/or Basic Service Set (BSS) color) for a set of APs installed on a floor in a building. Heuristics derived from monitoring the RF link quality indices of the clients connected to the APs on that floor over a brief time period can be used. Further, any optimizations to channel parameters allocation algorithms can be quantified by comparing the aggregate RF link quality indices recorded before/after the optimizations are introduced.

In some embodiments, the overall wireless link quality assessment (e.g., RF link quality index) is used for client steering/load balancing. Effectiveness of inter-AP and intra-AP client steering enhancements can be measured by comparing RF link quality indices for steered clients pre/post steering event.

In some embodiments, the overall wireless link quality assessment (e.g., RF link quality index) is used for detecting radio/network instabilities. Any instabilities/inefficiencies within the radio driver and firmware resulting in brief inconsistencies (e.g., packet drops, high latencies, etc.) can be isolated by monitoring the RF link quality indices for clients. Further any network level issues (e.g., DHCP server down, RADIUS server authentication failures, etc.) resulting in client onboarding failures can be effectively triaged as well.

In some embodiments, the overall wireless link quality assessment (e.g., RF link quality index) is used for monitoring impact of legacy clients. Rate combination component of the RF link quality index can be monitored to deduce trends in percentage of clients supporting relatively newer wireless standards on an average which can then be factored in to control or adjust air time fairness and radio scheduling algorithms to effectively improve overall fairness/channel utilization for a network.

In some embodiments, the network device 204 (e.g., the controller 234) is configured to compute and assign a score to quantify the RF link quality for a wireless client computed from various compelling factors in the radio subsystem. In some embodiments, the network device 204 (e.g., the controller 234) is configured to perform a wireless link quality assessment service (e.g., a wireless link quality assessment function). In some embodiments, the wireless link quality assessment function is a truth table of the below factors with the three possible outcomes: [Good, Average, Bad]. Three different classes of inputs to characterize client RF link quality include transmit/receive (Tx/Rx) rate combination optimality, which may be both uplink and downlink, per packet downlink latency, and miscellaneous factors. In some embodiments, the per packet downlink latency incurred in a radio subsystem is the time difference between a point of enqueue from a host to transmit completion recorded for a given MAC service data unit (MSDU). In some embodiments, the miscellaneous factors include drops in radio subsystem, the frequency of association/re-association attempts, and/or errors in monitoring of special packets (e.g., Dynamic Host Configuration Protocol (DHCP), Extensible Authentication Protocol (EAP), and/or Extensible Authentication Protocol (EAP) over LAN (EAPOL) 4 way Handshake (HS) counters). In some embodiments, the network device 204 (e.g., the controller 234) is configured to compute uplink and downlink RF link quality indices separately for a given client. However, because the latency is characterized only for downlink direction, the network device 204 (e.g., the controller 234) may consider one RF link (downlink or uplink) quality index and both downlink and uplink rate combinations. In some embodiments, the outcome of the wireless link quality assessment function is the Least Common Denominator (LCD) of the input scores computed from the respective metrics over a specific duration (e.g., last 5 minutes or any other suitable duration). For example, if downlink (DL) rate combination optimality is Good, Uplink rate combination optimality is Bad, Per packet downlink latency is Average, and Miscellaneous factors are Good, the overall score for the RF link quality is yielded as “BAD.”

In some embodiments, the rate optimality function of Tx/Rx Rate Combination Optimality is expressed as:

$${\sum }_{i = 0}^{M} r ( i ) * n ( i ) * [ 1 - PER ( i ) ] ,$$

where r(i) is a tunable function, n(i) is the fraction of MPDUs transmitted using MCS+SS (MCS stands for Modulation Coding Scheme, SS stands for Number of Spatial Streams) combo I, and PER (i), which is Packet Error Rate (PER) recorded while transmitting n(i) MPDUs, where I is a positive integer. The function r(i) can be tuned. In some embodiments, r(i) is:
{1 for high MCS index range [8-11], >1SS,
0.5 for high MCS range [8-11], 1SS,
0.5 for mid MCS range [4-7], >1SS,
0.25 for mid MCS range [4-7], 1SS,
0.25 for low MCS range [0-3], >1SS,
0.125 for low MCS range [0-3], 1SS}
   PER (i) is the PER recorded while transmitting n(i) MPDUs, e.g., M=5, i=0: MCS [0-3], 1SS; 1: MCS [0-3], >1SS; 2: MCS [4-7], 1SS; 3: MCS [4-7], >1SS; 4: MCS [8-11], 1SS; 5: MCS [8-11], >1SS. In some embodiments, PPDU bandwidth is intentionally ignored as it requires checking of transmit/receive mode for the physical layer protocol data unit (PPDU) (single user (SU) or multi-user (MU)-MIMO (Multiple-Input Multiple-Output) or Orthogonal frequency-division multiple access (OFDMA)) to be non OFDMA to avoid incurring incorrect penalties. For pre-IEEE 802.11n clients, the score may be either Not Available (NA) or Bad as max OFDM rate of 54 Megabits per second (Mbps)<MCS 3/1SS 11ax rate on 40 megahertz (MHz) channel.

Some examples of Tx/Rx Rate Combination scores and corresponding results are listed in Table-1. Specifically, in Table-1, different ranges of the Tx/Rx Rate Combination scores correspond to [Good, Average, Bad] results. In other embodiments, other ranges may be used to classify the results.

TABLE 1

| Score | |
|---|---|
| [Total MPDUs >50, | |
| N/A for pre-11n clients] | Result |
| >=0.5 | Good |
| 0.25 to 0.5 | Average |
| <0.25 | Bad |

Some examples of combination metrics available as part of per client counters under a client-metrics-minute datasource are listed below:
redis-clihgetall METRIC/access-points/access-point/ssids/ssid [name=DF8aba89ec5348b998d720c9ddf64e69]/clients/client [mac=26:15:10:2b:01:a0]/state/counters/rate-stats [type=mcs-4-7-1ss]
1. “dl-succ-mpdus”
2. “5231”
3. “dl-fail-mpdus”
4. “2486”
5. “ul-succ-mpdus”
6. “6049”
7. “ul-fail-mpdus”
8. “0”

Some examples of MCS/SS combinations are listed in Table-2.

TABLE 2

| MCS/SS | |
|---|---|
| combination | Key |
| MCS [0-3], 1SS | rate-stats[type=mcs-0-3-1ss] |
| MCS [0-3], >1SS | rate-stats[type=mcs-0-3-grt-1ss] |
| MCS [4-7], 1SS | rate-stats[type=mcs-4-7-1ss] |
| MCS [4-7], >1SS | rate-stats[type=mcs-4-7-grt-1ss] |
| MCS [8-11], 1SS | rate-stats[type=mcs-8-11-1ss] |
| MCS [8-11], >1SS | rate-stats[type=mcs-8-11-grt-1ss] |

Some examples of sample rate combination metrics reported for a client over a specific duration (e.g., in 5 minutes) that can be used to compute the final optimality score in both uplink and downlink directions are listed in Table-3.

TABLE 3

| Key | Value |
|---|---|
| rate-stats[type=mcs-4-7-1ss] | dl-succ-mpdus = 0, dl-fail-mpdus=0, ul- |
| | succ-mpdus=10, ul-fail-mpdus=2 |
| rate-stats[type=mcs-4-7-grt-1ss] | dl-succ-mpdus = 5, dl-fail-mpdus=0, ul- |
| | succ-mpdus=5, ul-fail-mpdus=5 |
| rate-stats[type=mcs-8-11-1ss] | dl-succ-mpdus = 15, dl-fail-mpdus=1, |
| | ul-succ-mpdus=10, ul-fail-mpdus=8 |
| rate-stats[type=mcs-8-11-grt-1ss] | dl-succ-mpdus = 50, dl-fail-mpdus=5, |
| | ul-succ-mpdus=6, ul-fail-mpdus=8 |
| Rest | All zeroes |

Downlink rate optimality score can be calculated as follows:
Total number of downlink success/failure MPDUs across all rate combinations (T)=5+15+1+50+5=76
i=0 to 2: rate-stats [type=mcs-0-3-1ss], rate-stats [type=mcs-0-3-grt-1ss], rate-stats [type-mcs-4-7-1ss]
r(i)*n(i)*[1-PER[i]]=0 as n[i]=0
i=3: rate-stats [type=mcs-4-7-grt-1ss]
r(3)=0.5, n(3)=[dl-succ-mpdus+dl-fail-mpdus]/T=[5+0]/76=0.066, PER[3]=dl-fail-mpdus/[dl-succ-mpdus+dl-fail-mpdus]=0/[5+0]=0
r(3)*n(3)*[1-PER[3]=0.5*0.067*[1-0]=0.033 i=4: rate-stats [type=mcs-8-11-1ss]
r(4)=0.5, n(4)=[dl-succ-mpdus+dl-fail-mpdus]/T=[15+1]/76=0.21, PER[4]=dl-fail-mpdus/[dl-succ-mpdus+dl-fail-mpdus]=1/[15+1]=0.063
r(4)*n(4)*[1-PER[4]]=0.5*0.21*[1-0.063]=0.098 i=5: rate-stats [type=mcs-8-11-grt-1ss]
r(5)=1, n(5)=[dl-succ-mpdus+dl-fail-mpdus]/T=[50+5]/76=0.72, PER[5]=dl-fail-mpdus/[dl-succ-mpdus+dl-fail-mpdus]=5/[50+5]=0.09
r(5)*n(5)*[1-PER[5]=1*0.72*[1-0.09]=0.66
Final score-0.033+0.098+0.66=0.79 [Good]

Uplink rate optimality score can be calculated as follows:
Total number of downlink success/failure MPDUs across all rate combinations (T)=10+2+5+5+10+8+6+8=54
i=0 to 1: rate-stats [type=mcs-0-3-1ss], rate-stats [type=mcs-0-3-grt-1ss] r(i)*n(i)*[1-PER[i]=0 as n[i]=0
i=2: rate-stats [type=mcs-4-7-1ss]
r(2)=0.25, n(2)=[ul-succ-mpdus+ul-fail-mpdus]/T=[10+2]/54=0.22, PER[3]=ul-fail-mpdus/[ul-succ-mpdus+ul-fail-mpdus]=2/[10+2]=0.17
r(2)*n(2)*[1-PER[2]=0.25*0.22*[1-0.17]=0.046
i=3: rate-stats [type=mcs-4-7-grt-1ss]
r(3)=0.5, n(3)=[ul-succ-mpdus+ul-fail-mpdus]/T=[5+5]/54=0.19, PER[3]=ul-fail-mpdus/[ul-succ-mpdus+ul-fail-mpdus]=5/[5+5]=0.5
r(3)*n(3)*[1-PER[3]]=0.5*0.19*[1-0.5]=0.048
i=4: rate-stats [type=mcs-8-11-1ss]
r(4)=0.5, n(4)=[ul-succ-mpdus+ul-fail-mpdus]/T=[10+8]/54=0.33, PER[4]=ul-fail-mpdus/[ul-succ-mpdus+ul-fail-mpdus]=8/[10+8]=0.44
r(4)*n(4)*[1-PER[4]]=0.5*0.33*[1-0.44]=0.092
i=5: rate-stats [type=mcs-8-11-grt-1ss]
r(5)=1, n(5)=[ul-succ-mpdus+ul-fail-mpdus]/T=[6+8]/54=0.26, PER[5]=ul-fail-mpdus/[ul-succ-mpdus+ul-fail-mpdus]=8/[6+8]=0.57
r(5)*n(5)*[1-PER[5]=1*0.26*[1-0.57]=0.11
Final score—0.046+0.048+0.092+0.11=0.30 [Average]

Per Packet Downlink Latency can be calculated as the number of packets recorded in three different latency distribution bins, for example, [0-40 millisecond (ms)], [40-90 ms], [>90 ms]. In some embodiments, only voice and video latencies are monitored for RF link quality scoring. In some embodiments, uplink latencies are computed either using Transmission Control Protocol (TCP) flow inspection or solicited from clients through some “vendor specific” mechanism. Some examples of Per Packet Downlink Latency conditions, scores, and corresponding results are listed in Table-4.

TABLE 4

| | Expected Mean | |
|---|---|---|
| | Opinion Score | |
| | (MOS) Score [From | |
| Condition | IxChariot tests] | Result |
| <15% of VO/VI | >4.0 | Good |
| packets in Avg + | | |
| Bad buckets | | |
| 15-25% of VO/VI | 3.5-4.0 | Average |
| packets in Avg + | | |
| Bad buckets | | |
| Else | <3.5 | Bad |

Some examples of latency distribution statistics available as part of per client counters under a clienttx-minute datasource are listed below:
redis-cli hgetall METRIC/access-points/access-point/ssids/ssid[name=NOffice_DG]/clients/client[mac=a0:51:0b:7c:7c:a2]/state/counters/tx-stats
193) “tx-hw-delay-be-good”
194) “280”
195) “tx-hw-delay-vi-good”
196) “883”
197) “tx-hw-delay-vo-good”
198) “2”

Some examples of WMM (Wireless Multimedia Extensions (WME), also known as Wi-Fi Multimedia (WMM)) Admission Control (AC) Type/Bucket type combinations are listed in Table-5.

TABLE 5

| WMM AC Type | Bucket type |
|---|---|
| Voice/Good | tx-hw-delay-vo-good |
| Voice/Average | tx-hw-delay-vo-avg |
| Voice/Bad | tx-hw-delay-vo-bad |
| Video/Good | tx-hw-delay-vi-good |
| Video/Average | tx-hw-delay-vi-avg |
| Video/Bad | tx-hw-delay-vi-bad |
| Background/Good | tx-hw-delay-bk-good |
| Background/Average | tx-hw-delay-bk-avg |
| Background/Bad | tx-hw-delay-bk-bad |
| Best effort/Good | tx-hw-delay-be-good |
| Best effort/Average | tx-hw-delay-be-avg |
| Best effort/Bad | tx-hw-delay-be-bad |

An example of sample score computation using metrics is described as follows. In this example, the sample latency distribution for voice/video traffic is reported for a client over a specific duration (e.g., the last 5 minutes).

### Voice:

tx-hw-delay-vo-good-2039
tx-hw-delay-vo-avg-25
tx-hw-delay-vo-bad-126%
in bad+avg bucket=[25+126]/2190=6.9%<15%
Score for voice traffic=

### Good

### Video:

tx-hw-delay-vo-good-1193
tx-hw-delay-vo-avg-23
tx-hw-delay-vo-bad-225%
in bad+avg bucket=[23+225]/1441=17% which is in 15-25% range
   Score for video traffic=Average
   Overall score=Average

### [As Latency for Video Traffic is Average Even-Though for Voice is Good]

In some embodiments, for Miscellaneous Factors, three classes of statistics that are monitored under this category for RF link quality scoring include packet drops in radio subsystem (e.g., enqueued from a host and dropped in target) during downlink transmissions, which can be extended to include drops due to REO/PN (Receive re-ordering or Packet number) field mismatch in a Counter Mode with Cipher Block Chaining Message Authentication Code Protocol (CCMP) header, Network subsystem errors, association/re-association frequency monitoring to account for roaming/steering inaccuracies, and “Special” packets monitoring using radio counters (e.g., DHCP lease negotiation errors monitoring, authentication failures accounting [EAPOL 4-way HS, EAP/dot1x auth failures]). Some examples of Per miscellaneous factors conditions and corresponding results are listed in Table-6.

TABLE 6

| Condition | Result |
|---|---|
| Tx-pkts-dropped-by- | Good |
| target <50%, | |
| Association attempts in | |
| last 5 mins- <=1, DHCP | |
| Rx - DHCP Tx <=3 | |
| Tx-pkts-dropped-by- | Average |
| target <50-90%, | |
| Association attempts in | |
| last 5 mins- >1 && <=3 | |
| Tx-pkts-dropped-by- | Bad |
| target < >90%, | |
| Association attempts in | |
| last 5 mins >3, DHCP | |
| Rx - DHCP Tx >3 | |

Some examples of metrics/events are described as follows. In some embodiments, packet drops in a radio subsystem is the number of packets enqueued from host captured in tx-pkts-enqueued-to-target but dropped in target captured in tx-pkts-dropped-by-target available under clienttx-minute data source. In some embodiments, DHCP Tx/Rx counters are tx-pkts-dhcp under clienttx-minute data source and rx-pkts-dhcp under clientrx-minute data source respectively. In some embodiments, association/re-association attempts are calculated by deducing number of client (re-)association attempts based on how many client association events were received in the last 5 minute window across APs on a floor map. A sample event is listed in Table-7.

TABLE 7

| | | | | | | |
|---|---|---|---|---|---|---|
| 02 Oct | A00A0006 | NWA1000 | stationState | info | 16646 | reasoncode=NOT_S |
| 2022 | 4704 | | | | 86885 | ET, sn=1, |
| 05:01: | | | | | 660 | bss=26:15:10:2d:02: |
| 19.853 | | | | | | 47, ssid=Nile |
| AM | | | | | | Employees, |
| | | | | | | band=5GHz |
| | | | | | | (gigahertz), aid=1, |
| | | | | | | state=associated, |
| | | | | | | timestamp=11, |
| | | | | | | mac=7a:db:44:d3:27 |
| | | | | | | :ee, |

An example of sample score computation using metrics/events is described as follows. In this example, statistics are reported for a client over a specific duration (e.g., the last 5 minutes).
tx-pkts-enqueued-to-target=35, tx-pkts-dropped-by-target=2===>tx-pkts-dropped-by-target/tx-pkts-enqueued-to-target=[2/35]=6%<50%—Good tx-pkts-dhcp=2, rx-pkts-dhcp=2===>rx-pkts-dhcp-tx-pkts-dhcp=0<=3—Good
Association/Re-association attempts deduced from client association events=1—Good
Overall score: Good

An RF Link Quality Function-Final Truth-table is listed in Table-8.

TABLE 8

| | | | | |
|---|---|---|---|---|
| | | | | Final |
| Downlink rate | Uplink rate | | | client |
| combination | combination | Downlink | | RF link |
| optimality | optimality | latency | Miscellaneous | quality |
| score | score | score | bucket score | score |

| | |
|---|---|
| Good | Good |
| Average for at-least one of the four factors and Good for the rest | Average |
| Bad for at-least one of the four factors and “Dont-Care” for the | Bad |
| rest | |

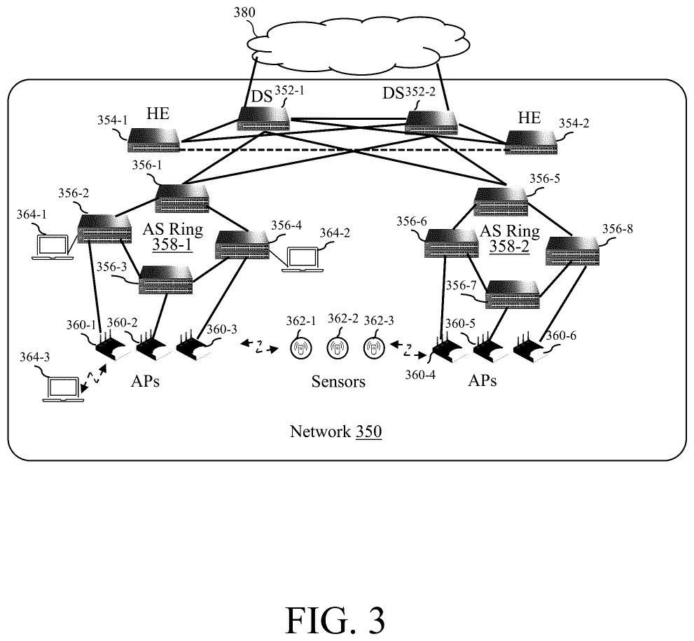

FIG. 3 depicts a network 350 that can be included in the communications system 100 depicted in FIG. 1. The network 350 depicted in FIG. 3 is an embodiment of the network 150 depicted in FIG. 1. However, the network 150 depicted in FIG. 1 is not limited to the embodiment depicted in FIG. 3. In the embodiment depicted in FIG. 3, the network 350 includes a pair of distribution switches (DSs) or distribution layer switches 352-1, 352-2 that are aggregation switches functioning as a bridge between core layer switches and access layer switches, a pair of head ends (HEs) or gateways 354-1, 354-2, a number of access switches (ASs) 356-1, 356-2, 356-3, 356-4, 356-5, 356-6, 356-7, 356-8 connected in rings 358-1, 358-2 that directly interact with lower level devices (e.g., wireless APs), a number of wireless APs 360-1, 360-2, 360-3, 360-4, 360-5, 360-6 connected to the ASs, a number of wireless sensors 362-1, 362-2, 362-3 that wirelessly connect to the wireless APs, and a number of network devices 364-1, 364-2, 364-3 that are connected to the ASs 356-2, 356-4, and the wireless AP 360-1 through cables or wires, for example, Ethernet cables. The DSs 352-1, 352-2, the HEs 354-1, 354-2, the ASs 356-1, 356-2, 356-3, 356-4, 356-5, 356-6, 356-7, 356-8, the wireless APs 360-1, 360-2, 360-3, 360-4, 360-5, 360-6, the wireless sensors 362-1, 362-2, 362-3, and/or the network devices 364-1, 364-2, 364-3 may be an embodiment of the network device 204 depicted in FIG. 2. The network devices 364-1, 364-2, 364-3 may be wired and/or wireless devices, for example, laptops, desktop PCs, or other wired devices. In some embodiments, each of the network devices 364-1, 364-2, 364-3 includes at least one wired transceiver (e.g., the transceiver 232) and at least one network port (e.g., the network port 238) that is used to connect to another communication device through at least one cable or wire, for example, at least one Ethernet cable. In some embodiments, as a wired device, each of the network devices 364-1, 364-2, 364-3 includes a wireless transceiver and at least one antenna (e.g., the antenna 236). In some embodiments, the network 350 also includes at least one wired communications device that is connected to the DS 352-1 or 352-2 through at least one cable or wire, for example, at least one Ethernet cable. In the embodiment depicted in FIG. 3, the DSs 352-1, 352-2 are connected to a network 380 (e.g., the Internet), which is connected to a network management module (e.g., the NM module 110 of the cloud server 102 depicted in FIG. 1). In some embodiments, the DSs 352-1, 352-2, the HEs 354-1, 354-2, and the ASs 356-1, 356-2, 356-3, 356-4, 356-5, 356-6, 356-7, 356-8 constitute a network service block (NSB), which is a basic building block for providing connectivity as a service and is a replicable block that can be scaled (e.g., expanded) to meet any deployment. In some embodiments, the NSB works in Layer 3 or L3 (i.e., the network layer, which is the third level (Layer 3) of the OSI Model) environment and is connected to other wired devices under L3 mode. A wired communications device of a customer (e.g., the network device 364-1, 364-2, or 364-3) can connect to the NSB on an L3 interface in a secured manner. Although the network 350 is shown with certain components and described with certain functionality herein, other embodiments of the network 350 may include fewer or more components to implement the same, less, or more functionality. For example, in some embodiments, the network 350 includes only one DS, more than two DSs, no HE, only one HE, more than two HEs, less than eight ASs, more than eight ASs, less than six wireless APs, more than six wireless APs, less than three wireless sensors, more than three wireless sensors, more than three network devices, and/or less than three network devices. Although each of the rings 358-1, 358-2 includes four ASs in the embodiment depicted in FIG. 3, in other embodiments, the number of ASs in each of the rings 358-1, 358-2 may be more than four or less than four. In another example, although the network 350 shown in FIG. 3 as being connected in certain topology, the network topology of the network 350 is not limited to the topology shown in FIG. 3. In some embodiments, the number of HEs and DSs is constant in the network 350 while the number of the wireless APs, the ASs, and the sensor(s) in the network 350 varies.

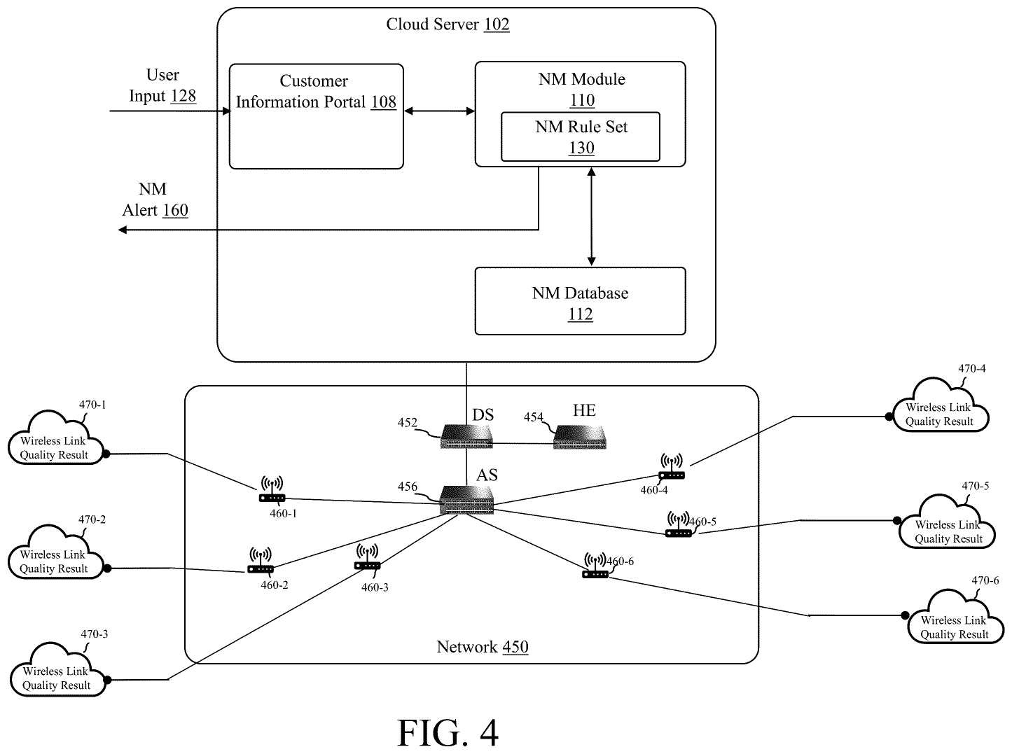

FIG. 4 depicts a network 450 that includes multiple wireless devices that are implemented as wireless APs 460-1, 460-2, 460-3, 460-4, 460-5, 460-6 configured to measure and monitor wireless link quality of the network 450 and/or to interact with the cloud server 102 depicted in FIG. 1 for wireless link quality management. The network 450 depicted in FIG. 4 is an embodiment of the network 350 depicted in FIG. 3. However, the network 350 depicted in FIG. 3 is not limited to the embodiment depicted in FIG. 4. In the embodiment depicted in FIG. 4, the network 450 includes the wireless APs 460-1, 460-2, 460-3, 460-4, 460-5, 460-6, at least one distribution switch (DS) or distribution layer switch 452 that is an aggregation switch functioning as a bridge between a core layer switch and an access layer switch, at least one head end (HE) or gateway 454, and at least one access switch (AS) 456 that directly interacts with lower level devices (e.g., wireless APs). The wireless APs 460-1, 460-2, 460-3, 460-4, 460-5, 460-6 depicted in FIG. 4 may be similar to or the same as the wireless APs 360-1, 360-2, 360-3, 360-4, 360-5, 360-6 depicted in FIG. 3. The DS 452 depicted in FIG. 4 may be similar to or the same as the DSs 352-1, 352-2 depicted in FIG. 3. The HE 454 depicted in FIG. 4 may be similar to or the same as the HEs 354-1, 354-2 depicted in FIG. 3. The AS 456 depicted in FIG. 4 may be similar to or the same as the ASs 356-1, 356-2, 356-3, 356-4, 356-5, 356-6, 356-7, 356-8 depicted in FIG. 3. Although the network 450 is shown in FIG. 4 with certain components and described with certain functionality herein, other embodiments of the network 450 may include fewer or more components to implement the same, less, or more functionality. For example, in some embodiments, the network 450 includes more than one DS, no HE, more than one HE, more than one AS, more than six wireless APs, less than six wireless APs, one or more wireless sensors, and/or one or more network devices.

In the embodiment depicted in FIG. 4, the wireless APs 460-1, 460-2, 460-3, 460-4, 460-5, 460-6 are configured to perform wireless link quality assessment of the network 450. In some embodiments, each of the wireless APs 460-1, 460-2, 460-3, 460-4, 460-5, 460-6 monitors at least one of user traffic and a wireless channel characteristic to generate wireless link quality assessment result information and to transmit the wireless link quality assessment result information to the cloud server 102 (e.g., the NM module 110 in the cloud server 102). In some embodiments, each of the wireless APs 460-1, 460-2, 460-3, 460-4, 460-5, 460-6 monitors only user traffic to generate wireless link quality factors. In some embodiments, each of the wireless APs 460-1, 460-2, 460-3, 460-4, 460-5, 460-6 monitors only a wireless channel characteristic to generate wireless link quality factors. In some embodiments, each of the wireless APs 460-1, 460-2, 460-3, 460-4, 460-5, 460-6 monitors multiple wireless channel characteristics to generate wireless link quality factors. In some embodiments, each of the wireless APs 460-1, 460-2, 460-3, 460-4, 460-5, 460-6 monitors user traffic and a wireless channel characteristic to generate wireless link quality factors. In some embodiments, each of the wireless APs 460-1, 460-2, 460-3, 460-4, 460-5, 460-6 monitors user traffic and multiple wireless channel characteristics to generate wireless link quality factors. In some embodiments, user traffic is measured by the amount of data moving across a computer network (e.g., the network 450) at any given time. Examples of user traffic include, without being limited to, voice traffic, video traffic, and/or data traffic. In some embodiments, user traffic is wireless user traffic that is communicated wirelessly. Examples of the wireless channel characteristics include, without being limited to, channel load (self and Overlapping Basic Service Set (OBSS) load), noise floor, and/or non-Wi-Fi interference. In some embodiments, the cloud server 102 (e.g., the NM module 110 in the cloud server 102) analyzes data (e.g., wireless link quality assessment result information) from the wireless APs 460-1, 460-2, 460-3, 460-4, 460-5, 460-6 to perform a management operation. In some embodiments, the wireless link quality assessment result information is used for channel planning, for example, to check the optimality of channel parameters allocation (e.g., operating channel, channel bandwidth, transmit power, and/or Basic Service Set (BSS) color) for a set of APs installed on a floor in a building. In some embodiments, the wireless link quality assessment result information is used for client steering/load balancing. In some embodiments, the wireless link quality assessment result information is used for detecting radio/network instabilities. In some embodiments, the wireless link quality assessment result information is used for monitoring impact of legacy clients.

In an example operation of the network 450 depicted in FIG. 4, the wireless APs 460-1, 460-2, 460-3, 460-4, 460-5, 460-6 can be enabled or disabled to perform wireless link quality assessment of the network 450. Initially, after the network 450 is deployed, all of the wireless APs 460-1, 460-2, 460-3, 460-4, 460-5, 460-6 boot up. Subsequently, radio sensors of the wireless APs 460-1, 460-2, 460-3, 460-4, 460-5, 460-6 monitor at least one of user traffic and a wireless channel characteristic to perform wireless link quality assessment of the network 450 to generate wireless link quality assessment result information and sends the generated wireless link quality assessment result information to the cloud server 102 (e.g., the NM module 110 in the cloud server 102). In some embodiments, user traffic is measured by the amount of data moving across a computer network (e.g., the network 450) at any given time. Examples of user traffic include, without being limited to, voice traffic, video traffic, and/or data traffic. In some embodiments, user traffic is wireless user traffic that is communicated wirelessly. Examples of the wireless channel characteristics include, without being limited to, channel load (self and OBSS load), noise floor, and/or non-Wi-Fi interference. For example, the wireless AP 460-1 monitors at least one of user traffic and a wireless channel characteristic to generate wireless link quality assessment result information 470-1 and transmits the wireless link quality assessment result information 470-1 to the cloud server 102 (e.g., the NM module 110 in the cloud server 102), the wireless AP 460-2 monitors at least one of user traffic and a wireless channel characteristic to generate wireless link quality assessment result information 470-2 and transmits the wireless link quality assessment result information 470-2 to the cloud server 102 (e.g., the NM module 110 in the cloud server 102), the wireless AP 460-3 monitors at least one of user traffic and a wireless channel characteristic to generate wireless link quality assessment result information 470-3 and transmits the wireless link quality assessment result information 470-3 to the cloud server 102 (e.g., the NM module 110 in the cloud server 102), the wireless AP 460-4 monitors at least one of user traffic and a wireless channel characteristic to generate wireless link quality assessment result information 470-4 and transmits the wireless link quality assessment result information 470-4 to the cloud server 102 (e.g., the NM module 110 in the cloud server 102), the wireless AP 460-5 monitors at least one of user traffic and a wireless channel characteristic to generate wireless link quality assessment result information 470-5 and transmits the wireless link quality assessment result information 470-5 to the cloud server 102 (e.g., the NM module 110 in the cloud server 102), and the wireless AP 460-6 monitors at least one of user traffic and a wireless channel characteristic to generate wireless link quality assessment result information 470-6 and transmits the wireless link quality assessment result information 470-6 to the cloud server 102 (e.g., the NM module 110 in the cloud server 102).

In some embodiments, at least one of the wireless APs 460-1, 460-2, 460-3, 460-4, 460-5, 460-6 includes a wireless transceiver and a controller connected to the wireless transceiver and configured to using the wireless transceiver, monitor at least one of user traffic and a wireless channel characteristic to generate wireless link quality factors, where each of the wireless link quality factors has a fixed number of possible outcomes and determine an overall wireless link quality assessment based on the wireless link quality factors using a truth table. In some embodiments, user traffic is measured by the amount of data moving across a computer network (e.g., the network 450) at any given time. Examples of user traffic include, without being limited to, voice traffic, video traffic, and/or data traffic. In some embodiments, user traffic is wireless user traffic that is communicated wirelessly. Examples of the wireless channel characteristics include, without being limited to, channel load (self and OBSS load), noise floor, and/or non-Wi-Fi interference. In some embodiments, a network management action is triggered based on the overall wireless link quality assessment. For example, the controller is configured to trigger a network management action based on the overall wireless link quality assessment. In some embodiments, the overall wireless link quality assessment is good, average, or bad. In some embodiments, each of the wireless link quality factors is good, average, or bad. In some embodiments, the controller is configured to determine the overall wireless link quality assessment as being good when each of the wireless link quality factors is good. In some embodiments, the controller is configured to determine the overall wireless link quality assessment as being bad when one of the wireless link quality factors is bad. In some embodiments, the wireless link quality factors include a transmit/receive (Tx/Rx) rate combination optimality factor, a per packet downlink latency factor, and a miscellaneous wireless link quality factor. In some embodiments, the controller is configured to determine the Tx/Rx rate combination optimality factor based on a rate optimality function. In some embodiments, the controller is configured to generate a downlink rate optimality score based on a rate optimality function or generate an uplink rate optimality score based on the rate optimality function. In some embodiments, the wireless link quality factors include uplink wireless link quality factors, and the overall wireless link quality assessment includes an overall uplink wireless link quality assessment. In some embodiments, the wireless link quality factors include downlink wireless link quality factors, and the overall wireless link quality assessment includes an overall downlink wireless link quality assessment.

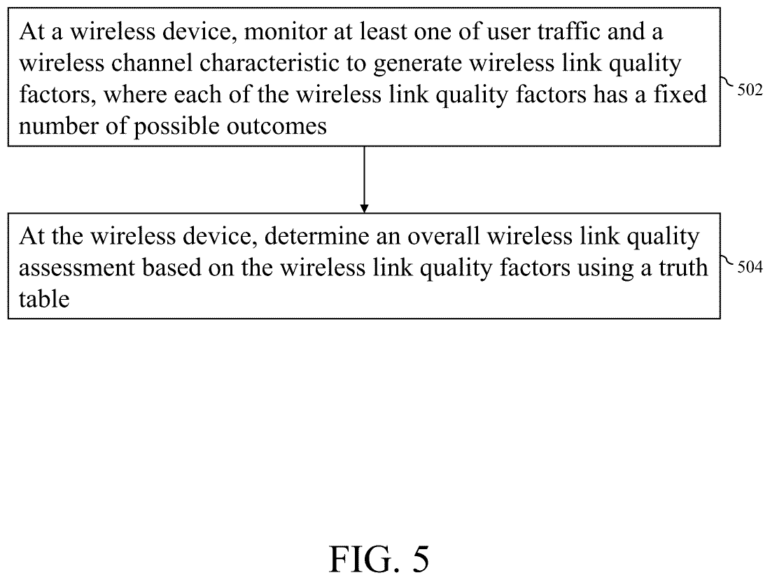

FIG. 5 is a process flow diagram of a method for assessing wireless link quality in accordance to an embodiment of the invention. According to the method, at block 502, at a wireless device, at least one of user traffic and a wireless channel characteristic are monitored to generate wireless link quality factors, where each of the wireless link quality factors has a fixed number of possible outcomes. At block 504, at the wireless device, an overall wireless link quality assessment is determined based on the wireless link quality factors using a truth table. In some embodiments, a network management action is triggered based on the overall wireless link quality assessment. In some embodiments, the method further includes triggering a network management action based on the overall wireless link quality assessment. In some embodiments, the overall wireless link quality assessment is good, average, or bad. In some embodiments, each of the wireless link quality factors is good, average, or bad. In some embodiments, at the wireless device, the overall wireless link quality assessment is determined as being good when each of the wireless link quality factors is good. In some embodiments, at the wireless device, the overall wireless link quality assessment is determined as being bad when one of the wireless link quality factors is bad. In some embodiments, the wireless link quality factors include a transmit/receive (Tx/Rx) rate combination optimality factor, a per packet downlink latency factor, and a miscellaneous wireless link quality factor. In some embodiments, the Tx/Rx rate combination optimality factor is determined based on a rate optimality function. In some embodiments, a downlink rate optimality score is generated based on a rate optimality function, or an uplink rate optimality score is generated based on the rate optimality function. In some embodiments, the wireless link quality factors include uplink wireless link quality factors, and the overall wireless link quality assessment includes an overall uplink wireless link quality assessment. In some embodiments, the wireless link quality factors include downlink wireless link quality factors, and the overall wireless link quality assessment includes an overall downlink wireless link quality assessment. In some embodiments, the wireless device includes a wireless access point (AP). In some embodiments, the wireless device includes a wireless station (STA). The wireless device may be similar to, the same as, or a component of the wireless devices 104-1, . . . , 104-N depicted in FIG. 1, the wireless device 204 depicted in FIG. 2, the DSs 352-1, 352-2, the HEs 354-1, 354-2, the ASs 356-1, 356-2, 356-3, 356-4, 356-5, 356-6, 356-7, 356-8, the wireless APs 360-1, 360-2, 360-3, 360-4, 360-5, 360-6, the wireless sensors 362-1, 362-2, 362-3, the network devices 364-1, 364-2, 364-3 depicted in FIG. 3, and/or the DS 452, the HE 454, the AS 456, and/or the wireless APs 460-1, 460-2, 460-3, 460-4, 460-5, 460-6 depicted in FIG. 4.

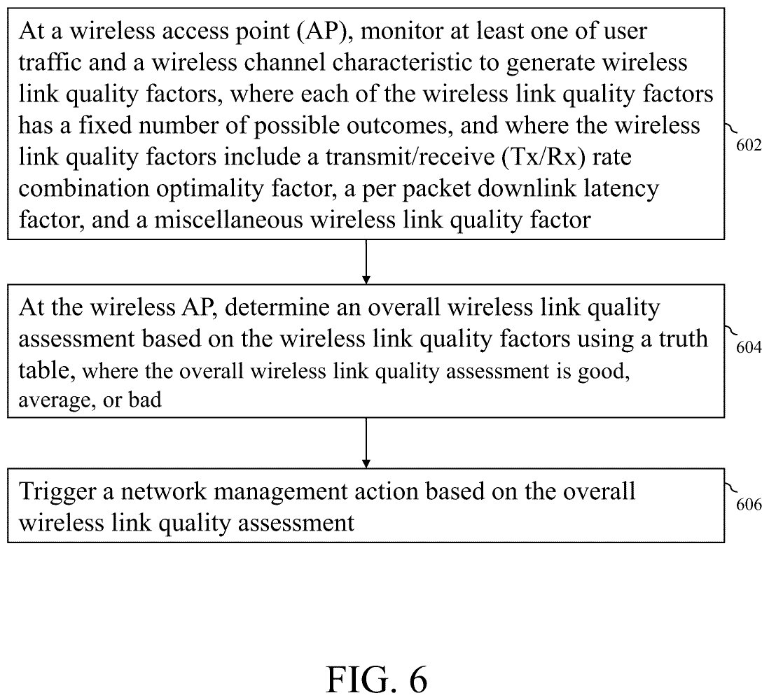

FIG. 6 is a process flow diagram of a method for assessing wireless link quality in accordance to an embodiment of the invention. According to the method, at block 602, at a wireless access point (AP), at least one of user traffic and a wireless channel characteristic are monitored to generate wireless link quality factors, where each of the wireless link quality factors has a fixed number of possible outcomes, and where the wireless link quality factors include a transmit/receive (Tx/Rx) rate combination optimality factor, a per packet downlink latency factor, and a miscellaneous wireless link quality factor. At block 604, at the wireless AP, an overall wireless link quality assessment is determined based on the wireless link quality factors using a truth table, where the overall wireless link quality assessment is good, average, or bad. At block 606, a network management action is triggered based on the overall wireless link quality assessment. The wireless AP may be similar to, the same as, or a component of the wireless APs 360-1, 360-2, 360-3, 360-4, 360-5, 360-6 depicted in FIG. 3 and/or the wireless APs 460-1, 460-2, 460-3, 460-4, 460-5, 460-6 depicted in FIG. 4.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for assessing wireless link quality, the method comprising:
at a wireless device, monitoring at least one of user traffic and a wireless channel characteristic to generate a plurality of wireless link quality factors, wherein each of the wireless link quality factors has a fixed number of possible outcomes; and
at the wireless device, determining an overall wireless link quality assessment based on the wireless link quality factors using a truth table.

2. The method of claim 1, wherein a network management action is triggered based on the overall wireless link quality assessment.

3. The method of claim 1, further comprising triggering a network management action based on the overall wireless link quality assessment.

4. The method of claim 1, wherein the overall wireless link quality assessment is good, average, or bad.

5. The method of claim 4, wherein each of the wireless link quality factors is good, average, or bad.

6. The method of claim 5, wherein at the wireless device, determining the overall wireless link quality assessment based on the wireless link quality factors using the truth table comprises at the wireless device, determining the overall wireless link quality assessment as being good when each of the wireless link quality factors is good.

7. The method of claim 5, wherein at the wireless device, determining the overall wireless link quality assessment based on the wireless link quality factors using the truth table comprises at the wireless device, determining the overall wireless link quality assessment as being bad when one of the wireless link quality factors is bad.

8. The method of claim 1, wherein the wireless link quality factors comprise a transmit/receive (Tx/Rx) rate combination optimality factor, a per packet downlink latency factor, and a miscellaneous wireless link quality factor.

9. The method of claim 8, wherein at the wireless device, monitoring at least one of the user traffic and the wireless channel characteristic to generate the wireless link quality factors comprises determining the Tx/Rx rate combination optimality factor based on a rate optimality function.

10. The method of claim 8, wherein at the wireless device, monitoring at least one of the user traffic and the wireless channel characteristic to generate the wireless link quality factors comprises:
generating a downlink rate optimality score based on a rate optimality function; or
generating an uplink rate optimality score based on the rate optimality function.

11. The method of claim 1, wherein the wireless link quality factors comprise a plurality of uplink wireless link quality factors, and wherein the overall wireless link quality assessment comprises an overall uplink wireless link quality assessment.

12. The method of claim 1, wherein the wireless link quality factors comprise a plurality of downlink wireless link quality factors, and wherein the overall wireless link quality assessment comprises an overall downlink wireless link quality assessment.

13. The method of claim 1, wherein the wireless device comprises a wireless access point (AP).

14. The method of claim 1, wherein the wireless device comprises a wireless station (STA).

15. A wireless device comprising:
a wireless transceiver; and
a controller connected to the wireless transceiver and configured to:
using the wireless transceiver, monitor at least one of user traffic and a wireless channel characteristic to generate a plurality of wireless link quality factors, wherein each of the wireless link quality factors has a fixed number of possible outcomes; and
determine an overall wireless link quality assessment based on the wireless link quality factors using a truth table.

16. The wireless device of claim 15, wherein a network management action is triggered based on the overall wireless link quality assessment.

17. The wireless device of claim 15, wherein the controller is further configured to trigger a network management action based on the overall wireless link quality assessment.

18. The wireless device of claim 15, wherein the overall wireless link quality assessment is good, average, or bad.

19. The wireless device of claim 15, wherein each of the wireless link quality factors is good, average, or bad.

20. A method for assessing wireless link quality, the method comprising:
at a wireless access point (AP), monitoring at least one of user traffic and a wireless channel characteristic to generate a plurality of wireless link quality factors, wherein each of the wireless link quality factors has a fixed number of possible outcomes, and wherein the wireless link quality factors comprise a transmit/receive (Tx/Rx) rate combination optimality factor, a per packet downlink latency factor, and a miscellaneous wireless link quality factor;
at the wireless AP, determining an overall wireless link quality assessment based on the wireless link quality factors using a truth table, wherein the overall wireless link quality assessment is good, average, or bad; and
triggering a network management action based on the overall wireless link quality assessment.
